(19) United States
(12) Patent Application Publication
(10) Pub. No.: US 2006/0097916 A1
(43) Pub. Date: May 11, 2006

(54) Antenna array

(76) Inventor: Mirjana Bogosanovic, Auckland (NZ)

Correspondence Address: SHELDON & MAK, INC, 225 SOUTH LAKE AVENUE, 9TH FLOOR, PASADENA, CA, 91101, US

(21) Appl. No.: 10/530,119

(22) PCT Filed: Oct. 3, 2003
(86) PCT No.: PCT/NZ03/00223

§ 371 Date: Sep. 8, 2005

(30) Foreign Application Priority Data
Oct. 4, 2002 (NZ) 521823

(51) Int. Cl. H01Q 1/38; H01Q 21/00

(52) U.S. Cl. 343/700 MS; 343/853

(57) ABSTRACT

A focussed beam antenna array includes a plurality of element antennas and a feeding network connecting the element antennas to one or more microwave sources. A feeding coefficient is provided for each element antenna. One or both of i) the relative position of the element antennas, and ii) the feeding coefficient for each element antenna may be selected to cause microwave signals transmitted from the antenna array to focus on a required focal surface. The array enables microwave signals to be focussed in the near field zone, providing particular advantages in applications such as sensing a property (for example permittivity or related parameters such as moisture content and density) of objects such as fruit or wood.

### CROSS-REFERENCE TO RELATED APPLICATIONS

The present Application is a United States national phase application of International Patent Application No. PCT/NZ2003/00223, titled “Antenna Ray,” filed Oct. 3, 2003, which claims priority from New Zealand Patent Application No. 521823, titled, “Antenna Ray,” filed Nov. 17, 2002, the contents of which are incorporated in this disclosure by reference in their entirety.

### FIELD

The present invention relates to electromagnetic antennas and in particular, but not exclusively, to microwave antennas suitable for a microwave sensor for use in the detection of material characteristics of objects

### BACKGROUND

Industrial sensing has been evolving and there has been an increasing interest in development of new sensor solutions. One of the problems that has been solved by using microwave sensing techniques is the inspection of the material properties in the interior of a dielectric object. This can be achieved by measuring the interaction of an electromagnetic wave with an object under test, either by measuring its complex permittivity, or by measuring the scattering of the radiated wave from the object.

Most of the techniques for permittivity measurements are destructive, requiring the sample to be cut and fitted into the measurement device. Examples are the use of a resonant cavity and a waveguide cell for permittivity measurement. However, in such cases, the sample preparation is not only time consuming, but also inappropriate for many practical applications, particularly the inspection of natural products. A specific example is the inspection of apples, where the goal is to detect the apples with a water core (rotten). This can be easily detected by means of a resonant cavity microwave sensor, since the water in the damaged apples significantly increases the measured permittivity. However, it is clear that cutting every apple is a poor solution.

There are other techniques for permittivity measurement, which do not require sample preparation, where sensors such as a coaxial probe and an open waveguide flange are used. However, these techniques require good contact between the sensor and the measured object. Very often this is undesirable, for example in the food processing industry, where cleaning the probe may need to be performed after every measurement to meet health requirements. Furthermore, the contact between the probe and the measured object presents a problem for objects with curved or irregularly shaped surfaces, as the required uniform pressure of the probe onto the surface cannot easily be achieved.

As a solution to these problems, the interaction of the radiated field with the material under test may measured. This measurement setup is used for non-destructive and non-contact sensing.

Using such a system, it is possible to measure the permittivity of the material under test or, as is often needed in practice, to perform an inspection of a product's quality by comparing measured attenuations through both perfect and damaged samples. Horn antennas may be used to transmit and receive the microwave energy and the transmission coefficient, or attenuation in dB, is measured.

However, when dielectric objects such as natural products are measured, small discontinuities only introduce a small change in attenuation, for example of the order of 0.1 dB. It is difficult to detect such small changes using horn antennas, particularly when the scattering from the surrounding object is of the same order of magnitude, making these measurements inconclusive in most cases.

In such applications, it may be advantageous to have a measurement system with a focused beam, in which the electromagnetic energy is converging towards the object under test (OUT). When the OUT is positioned in the beam waist (focus), all the energy is confined to pass through it, which significantly improves the sensitivity of the measurement system and the measured change in attenuation can be several dB. The advantage of the focused beam system is its capability to filter out reflections from adjacent objects. The measurement errors due to specular and diffuse reflections from the adjacent objects are minimised in this system.

Focused-beam systems have been developed that focus a horn antenna's diverging beam, with a dielectric lens as a focusing device. In such a system, most of the energy is transferred from one feed horn to the other, without significant losses and reflection interference from surrounding objects.

This system suffers from several disadvantages. First, the size of the system is usually very large, since the dielectric lens design should have dimensions covering several wavelengths in order to prevent waves diffracted from the lens edges interfering with the measurement. Even if the lens is mounted on the mouth of the horn, the size of the horn itself is significant and not practical for many applications.

A beamforming microstrip constrained lens (MCL) is described in the specification of U.S. Pat. No. 4,721,966. The term ‘constrained’ is used to characterise the class of microwave lenses defined as any optical transforming device in which the rays are guided and constrained to follow discrete paths that may have different propagation characteristics. The MCL includes a number of guiding elements to receive microwave energy from a horn antenna and the path lengths and the geometries of these guiding elements, which constitute the lens, are designed so that the exit rays produce the desired phase and amplitude distributions across the aperture.

The application of either a MCL or a dielectric lens in focused beam systems has a number of disadvantages. The problems that occur with these systems are: defocusing with a change of frequency, diffraction of the direct wave from the lens edges and its intereference with the focused beam, high attenuation of the electromagnetic wave by the lens material, the size of the measurement system, high fabrication costs and expensive lens material. In addition to these problems, MCL systems have a significant problem with spurious radiation from transmission lines and coupling slots.

It is thus an object of the present invention to provide a focussing electromagnetic antenna that overcomes or alleviates at least some of the problems in focussing anetannas at present, or at least to provide the public with a useful alternative.

Further objects of the present invention may become apparent from the following description.

### SUMMARY

According to one aspect of the invention, there is provided a focussed beam antenna array comprising a plurality of element antennas and a feeding network connecting said element antennas and one or more microwave sources and providing a feeding coefficient for each element antenna, wherein either one or both of:

the relative position of the element antennas, and

the feeding coefficient for each element antenna

are selected to cause microwave signals transmitted from the antenna array to focus on a required focal surface.

Preferably, the relative position of the element antennas and/or the feeding coefficient for each element antenna is selected to position the beam waist in a predetermined position in a transversal plane relative to the direction of propagation of said microwave signals.

Preferably, the required focal surface is at a predetermined focal distance within the near field zone from the element antennas.

Preferably, said feeding network includes a power divider or network of power dividers between said one or more sources and said element antennas, so that each element antenna is fed with microwave signals of substantially equal amplitude.

Preferably, the element antennas are located relative to each other in a preselected configuration, the configuration selected to assist the focussing of said electromagnetic signals transmitted from said element antennas.

Preferably, the element antennas are located at a separation of approximately one wavelength of the transmitted microwave signals from each other.

Preferably, the feeding coefficient for each element antenna is determined to cause a phase variation in signals received by the element antennas that is substantially equivalent to the phase variation that would occur in signals transmitted through a portion of a dielectric thin lens having the same radial distance as the element antenna.

Preferably, the feeding network may include contolled electronic phase shifters controlled by control means to allow variation of the location of the focal surface.

Preferably the antenna array includes no reflective or refractive elements.

Preferably, the antenna array includes no lenses.

According to another aspect of the present invention there is provided a method of producing a focussed beam antenna array, the method comprising providing one or more element antennas for receiving microwave signals from a microwave source and transmitting microwave signals, wherein the method includes one or both of:

locating the element antennas at certain locations relative to each other; and

selecting a certain feeding coefficient for each element antenna

in order to achieve a phase variation in microwave signals across the antenna array that causes the antenna array to have a predetermined focal surface at a required distance from said element antennas.

Preferably, the method includes selecting the feeding coeffcients for each element antenna to position the beam waist in a required position in a transversal plane relative to the direction of propagation of said microwave signals.

Preferably, the method includes locating the element antennas with varying separation in a plane transverse to a direction of transmission of the antenna array in order to achieve a focussing effect.

Preferably, the method includes locating the element antennas at different locations along the axis of transmission of the antenna array in order to achieve a focussing effect.

Preferably, the focal surface is located within the near field zone of said antenna array.

Preferably, the method may include selecting the feeding coefficient for each element antenna so that the antenna array simulates a dielectric lens.

Preferably, the method may include either or both of changing the electrical length of transmission lines to each antenna alement and using phase shifters to set the feeding coefficient for each element antenna.

In a further aspect the invnetion provides a sensor for sensing a property of an object, the sensor comprising:

a) a focussed beam transmitting antenna array comprising a plurality of element antennas and a feeding network connecting said element antennas and one or more microwave sources and providing a feeding coefficient for each element antenna, wherein either one or both of:

the relative position of the element antennas, and

the feeding coefficient for each element antenna

are selected to cause microwave signals transmitted from the antenna array to focus on the object;

b) a receiving antenna to receive microwave signals that have passed through the object; and

c) a detection means to determine an indication of the property.

Preferably the detection means determines an indication of an electrical property of the object.

Preferably the electrical property is permitivitty.

Preferably the property includes one or more of permittivity, moisture content, density.

Preferably the detection means includes means to compare the detected indication with a reference indication and provide a signal if the detected indication is greater then or less than the reference indication.

In a further aspect the invnetion provides a method of sensing a property of an object, the method comprising:

a) providing one or more element antennas for receiving microwave signals from a microwave source

b) performing one or both of:

locating the element antennas at selected locations relative to each other, and

selecting a certain feeding coefficient for each element antenna

in order to achieve a phase variation in microwave signals across the antenna array that causes the antenna array to have a predetermined focal surface at a required distance from the element antennas;

c) transmitting microwave signals from the array to the object so that the microwave signals transmitted from the antenna array focus on the object;

d) receiving microwave signals that have passed through the object; and

e) using the received signals to determine an indication of the property of the object.

Preferably the method includes the steps of comparing the detected indication with a reference indication and providing a signal if the detected indication is greater then or less than the reference indication.

Further aspects of the present invention, which should be considered in all its novel aspects may become apparent from the following description, given by way of example only and with reference to the accompanying drawings.

### DRAWINGS

FIG. 1 shows a schematic representation of an antenna array in accordance with an aspect of the present invention;

FIG. 2 shows a diagramatic representation of a transformation of microwave signals from a diverging beam to a converging beam;

FIG. 3 shows a top view of an antenna array in accordance with an aspect of the present invention, showing one possible positioning of element antennas;

FIG. 4 shows a bottom view of the antenna array of FIG. 3 showing a feeding network of transmission lines for the element antennas;

FIG. 5 shows a side view of the antenna array of FIGS. 3 and 4;

FIG. 6A shows a graph of phase distribution of array feeding coefficients for a 4×4 element antenna array;

FIG. 6B shows a top view of the graph of FIG. 6A;

FIG. 7A shows a graph of phase distribution of array feeding coefficients for a 12×12 element antenna array;

FIG. 7B shows a top view of the graph of FIG. 7A;

FIG. 8A shows a graph of the theoretical normalised power distribution at focal distance in the transversal plane for a 4×4 element antenna array;

FIG. 8B shows a top view of the graph of FIG. 8A;

FIG. 9A shows a graph of the theoretical normalised power distribution at focal distance in the transversal plane for a 4×4 element antenna array;

FIG. 9B shows a top view of the graph of FIG. 8A;

FIG. 10A shows a graph of the theoretical phase distribution at focal distance in the transversal plane for a 4×4 element antenna array;

FIG. 10B shows a graph of the theoretical phase distribution at focal distance in the transversal plane for a 12×12 element antenna array;

FIG. 11A shows a plan view of an antenna element according to a preferred embodiment of the invention;

FIG. 11B shows a side view of the element of FIG. 11A;

FIG. 12A shows a graph of measured normalised power distribution magnitude for a 4×4 elment anteanna array with 126 mm focal distance;

FIG. 12B shows a top view of the graph of FIG. 12A;

FIG. 13 shows a graph of the phase distribution claculated from the measurements shown in FIGS. 12A and 12B;

FIG. 14 shows a graph of predicted and normalised power distribution for a 4×4 element antenna array having a focal length of 126 mm at 10 GHz;

FIG. 15 shows a graph of predicted and normalised power distribution for a.4×4 element antenna array having a focal length of 300 mm at 10 GHz;

FIG. 16 shows a perspective view of a sample used to test the sensitivity of the antenna array of the invention;

FIG. 17 shows a graph of the measured real part of the transmission co-efficient for seven dielectric samples shaped as shown in FIG. 16;

FIG. 18 shows a graph of the measured imaginary part of the transmission co-efficient for seven dielectric samples shaped as shown in FIG. 16; and

FIG. 19 shows a schematic representation of an antenna array in accordance with an aspect of the present invention used is a measurement or sensing application.

### DESCRIPTION

The present invention provides an antenna solution with a converging beam. The antenna solution may have particular application to the focussing of electromagnetic signals and may be particularly suited to focussing signals in the near field zone.

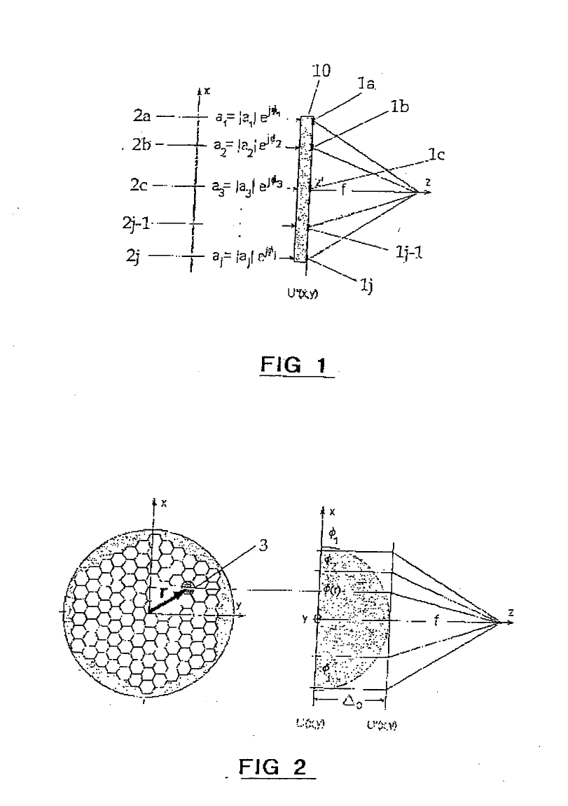

FIG. 1 shows a diagrammatic representation of an antenna array 100 in accordance with the present invention. The antenna array 100 includes a substrate 10 on which is located a number of element antennas 1a-1j, each of which are fed by a corresponding transmission line 2a-f. Each transmission line 2a-f provides a feeding coefficient indicated by a1-aj for its respective element antenna 1a-f and is fed from a microwave signal source (not shown). The feeding coefficient for an element antenna is the amplitude and phase of that element antenna with respect to a reference element. Throughout this specification, locations are indicated with reference to the coordinate system x, y, z as shown in FIGS. 1 and 2 and r is the radial distance in the x,y plane from the centre of the antenna array 100 (see FIG. 2).

Adjustment of the phase of electromagnetic signals can be achieved by adjusting the feed coefficients al to aj, for the elements of the antenna array provided on the z=z′ plane. With particular reference to FIG. 2, to calculate the required feeding coefficients, a thin dielectric lens may be observed. The choice of the lens geometry by which the focusing effect is achieved is arbitrary. The description herein is given with particular reference to an embodiment of the invention using a spherical lens as a reference. However, those skilled in the relevant arts will appreciate after reading this specification that other lens contours, for example a hyperbolic contour, may be used.

The lens surface is discretised into equal sized cells 3. When fabricating the antenna array 100 every elemental cell 3 contains an element antenna 1 for the array counterpart of the lens. In order to transform the diverging wavefront U(x,y) into a converging wavefront U′(x,y), generally, or transform a plane wave into a spherical converging wave, by analogy with thin lenses, an element antenna 1 at the radius r from the lens centre should have a phase of the feeding coefficient defined by equation 1

$$ϕ ( r ) = \frac{π {r}^{2}}{λ f} \qquad equation 1$$

In equation 1 λ is a wavelength and f is the required focal point distance.

Therefore, if the incoming wave U(x,y) is a plane wave U(x,y)=E=1, then the field distribution after the lens is equal to E′, as shown in equation 2.

$${E}^{′} = exp ( j \frac{2 π}{λ} n {Δ}_{0} ) exp ( - j \frac{π {r}^{2}}{λ f} ) \qquad equation 2$$

In equation 2 n is the index of refraction and Δ0 is the thickness of the lens for y=0.

Therefore, the phase of the feeding coefficient 2 for an element antenna is calculated from the position of the element antenna 1 and comparing it with the ray in the dielectric lens at the same position. Thus, the focusing effect is achieved by controlling the relative phase difference between the element antennas feeding coefficients 2. All element antennas 1 in the array will typically have equal feeding amplitude. The focal surface need not be planar, although in many situations it is anticipated that a planar focal surface would be preferable.

Physical displacement of the element antennas 1 may be used in order to achieve a required phase distribution. This is a feature that can also achieve the focusing effect and provides an additional degree of freedom, which can be used together with or independently from the electrical line length variation to achieve the required focus.

In particular, the element antennas 1 if located on a plane may have a variable separation, so that phasing is achieved by antenna position, instead of or in addition to variation in the relative phase of the feeding coefficients. The element antennas 1 need not be constrained to a common plane, providing a further degree of freedom. In one embodiment, the element antennas 1 may be located on a curved surface.

For equidistant element antennas 1, their separation is preferably not larger than one wavelength because of the resulting undesirable “grating lobe” appearance. The minimum distance between element antennas 1 is dictated by the element size and to avoid excessive unwanted mutual coupling. Taking these factors into account, a currently anticipated preferred separation of element antennas is approximately one wavelength.

Furthermore, the relative element antenna location and/or the relative electrical line length/phase of the feeding coefficients for the element antennas 1 need not be symmetrical about the transmission axis. In particular, the beam waist transversal position can be changed using asymmetrical phase distribution.

An antenna array 100 with a converging beam in a near field zone, i.e. having a focal plane within a distance from 3λ up to 2D²/λ (D is array diameter, λ is the wavelength) from the element antennas 1, may include a planar microstrip array, with two layers of substrates having a common ground plane between them.

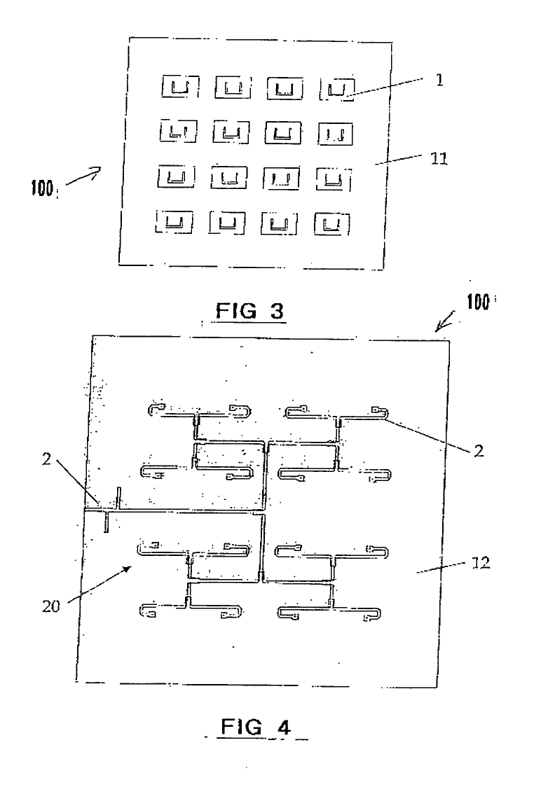

Referring to FIGS. 3 and 4, an example of a 4×4 array solution is provided. On the top layer 11 is the array of element antennas 1, see FIG. 3. On the back layer 12 is the feeding network 20 comprising transmission lines 2, see FIG. 4. Between the top layer 11 and back layer 12 is a common ground plane 13 as shown in FIG. 5. The elements are shown in FIG. 5 as being fed by wires 14, but other suitable electromagnetic coupling may be used. Such other connections, for example a simple aperture of the correct dimensions may be used to reduce cost. An advantage with the wires 14 is that they are reliable and cause less spurious radiation

The electrical length θ to each element antenna 1 is equal to the phase φ determined by equation 1. Therefore, the length of the transmission lines, L can be calculated using equation 3:

$$L = \frac{θ ( deg ) \cdot {λ}_{g}}{360} \qquad equation 3$$

where λg is wavelength on the transmission line.

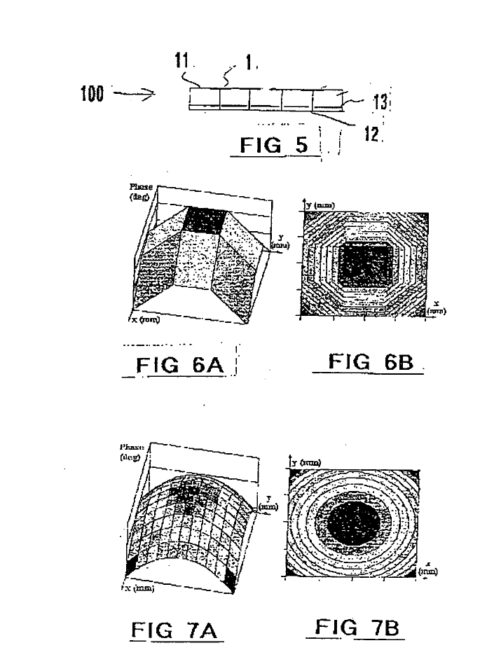

Using this expression, an approximation of the spherical phase distribution required for arrays with different number of elements may be deduced and results are plotted for two example arrays with 16 (4×4 planar array) and 144 elements (12×12 planar array) respectively, are presented in FIGS. 6A and 7A. FIGS. 6B and 7B are plan or top views of the graphs of FIGS. 6A and 7A respectively.

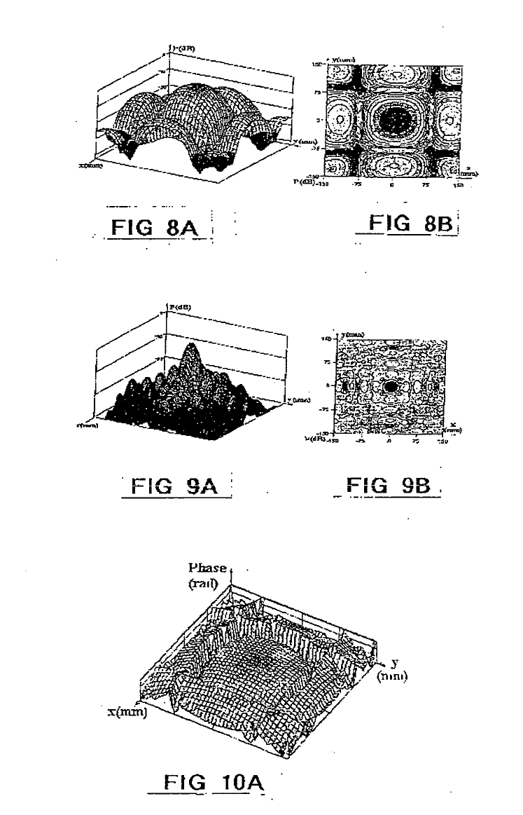

Using the phase distributions shown in FIGS. 6A-7B, and assuming isotropic sources, the resulting field power magnitude distribution at the focal distance can be calculated and the results are shown in FIGS. 8A-9B.

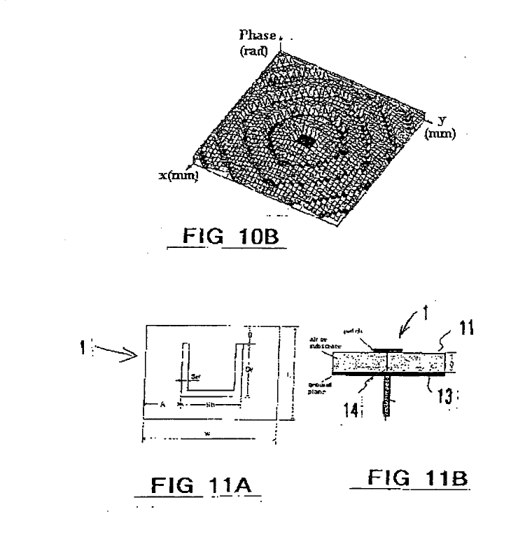

FIGS. 10A and 10B show the calculated phase distributions at the focal distance for a 4×4 array and a 12×12 array, respectively.

The beam waist is taken to be the region less than or equal to 3 dB below the maximum signal level. This is presented as a near-circular region in the centre of FIGS. 8B and 9B. The beam waist diameter for the 4×4 array is 70 mm, while that for the 12×12 array is 25 mm. These results were obtained at 10 GHz, with the separation of the isotropic elements being 30 mm, and a design focal distance of 300 mm. The criteria adopted for phase curvature within the beam waist is the same as that usually adopted for the plane wave approximation, namely it should be smaller than 22.5 degrees (π/8 radians).

As can be seen, the number of elements has an influence on the beam waist size, where, as expected, the larger array has a smaller beam waist than the smaller. However, the 4×4 array offers smaller size and consequently is easier and cheaper to fabricate, which are the important considerations in practice. The number of elements used in a focused array is therefore a compromise between performance, size and cost.

### EXAMPLE ARRAY IMPLEMENTATION

One way of implementing an array according to the invention is as follows. First, the lens phase distribution is mapped to the array feeding coefficients. A rectangular mapping grid may be chosen and the phase of each element from its (x,y) position calculated using equation (3). This shape of mapping grid is particularly convenient for the implementation presented here, because a corporate feeding network with binary power dividers is used (see FIG. 4). Specifically, the rectangular arrangement of elements preserves the symmetry and is suitable for the phase control in individual branches. In the particular example of a 4×4 array the distance between neighbouring elements was chosen to be one wavelength (30 mm) at the nominal central frequency of 10 GHz. A smaller distance cannot be used because of the antenna element size, while a larger distance is not recommended because of the appearance of the grating lobes.

TABLE I

| | para | | | | | | | |
|---|---|---|---|---|---|---|---|---|
| | H | L | w | Sv | Sh | Sw | A | B |
| dimension | 2.2 | 11.3 | 18.0 | 6.8 | 5.7 | 0.8 | 6.1 | 1.9 |

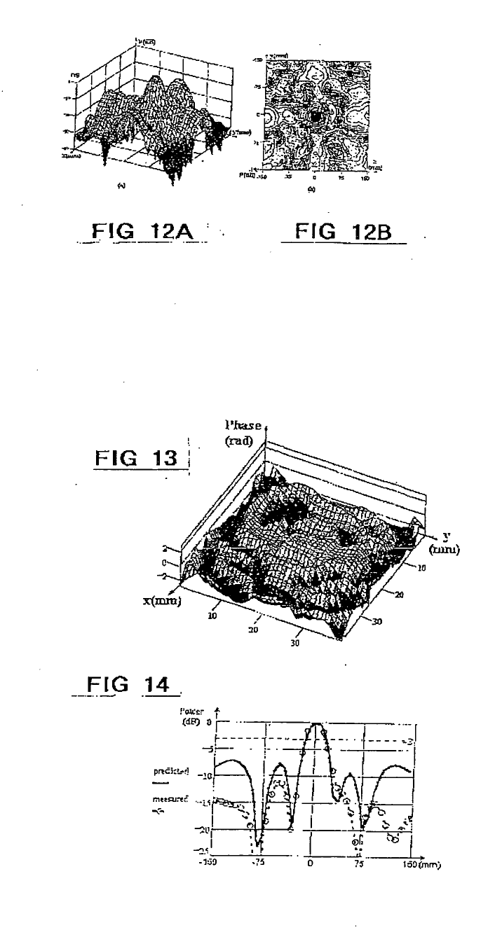

The next step is the selection of the antenna element. Printed antennas are a very popular choice for arrays due to their low profile, small weight and easy fabrication. However they suffer from very narrow bandwidth. Many methods for bandwidth broadening have been investigated and are known to those skilled in the art to which the invention relates. In a preferred embodiment of the invention with a 4×4 array, a U slotted patch antenna may be used with the dimensions as given in Table I. The dimensions correspond with the element shown in FIGS. 11A and 11B.

The space between the patch and the ground plane may be an air gap or may be filled with a low loss foam (εr≈1) for additional mechanical robustness. The antenna array of this example is designed for a frequency range from 10 to 12 GHz, and a 26% bandwidth is achieved with the U slotted patch presented in FIGS. 11A and 11B.

The preferred microstrip substrate used for the array feeding network was Rogers RO4003, with εr=3.38 and tanδ=0.0002 at 10 GHz, while thickness was h=0.5 mm. The array may be fed by a passive corporate feeding network 20, with a planar microstrip power divider such as a Wilkinson power divider as a main element and the required phase distribution may be obtained by selecting the electrical lengths of the transmission lines to each element.

If an active feeding network 20 is used, with signal amplification for every element antenna 1, a high power signal may be obtained. In addition, diode phase shifters such as p-i-n diode phase shifters are a suitable solution that may be used for phase adjustment. With a suitable controller for the diode phase shifters, the location of the focal surface both along the transmission path and transverse to the transmission path may be varied.

There are several choices for an element antenna 1, such as dipole, rectangular or circular patch antenna, bowtie, U slotted patch and the like. If a microstrip patch antenna is used as a radiating element, the resulting array may be very narrowband, mainly due to the characteristics of the patch. However, a broadband microstrip element antenna can be used, such as a U-slotted rectangular patch with thick rigid foam as a substrate, or a slotted rectangular microstrip antenna.

Thus, the problems with energy leakage and poor efficiency are addressed by feeding the lens by the microstrip feeding network using power dividers. Efficiency may be improved as the wave does not have to pass through a dielectric lens, there may be less interference with radiation from the feeding antenna and the antenna does not require adjustment dependent on frequency. Moreover, the microstrip array focusing antenna has a compact format, small size and is very easy to use. It is a lightweight structure, with inexpensive fabrication.

The distribution of element antennas 1 in the array need not be uniform. Other distribution patterns may be used as required, comprising without limitation randomly distributed antenna arrays.

Turning to FIGS. 12-15 experimental results are shown. FIG. 12A shows a plot of the measured normalised power ditribution magnitude for a 4×4 array according to the implementation example described above with a 126 mm focal distance. It can be seen that the field magnitude has its maximum value at the centre of the array, at the focal point, or more accurately the focal region or focal surface. FIG. 12B is a top or plan view fo FIG. 12A. The circle in the centre has its borders 3 dB below the maximum value, and thus the diameter of the circle represents the extent of the beam waist. FIG. 13 shows the measured phase distribution for the 4×4 array.

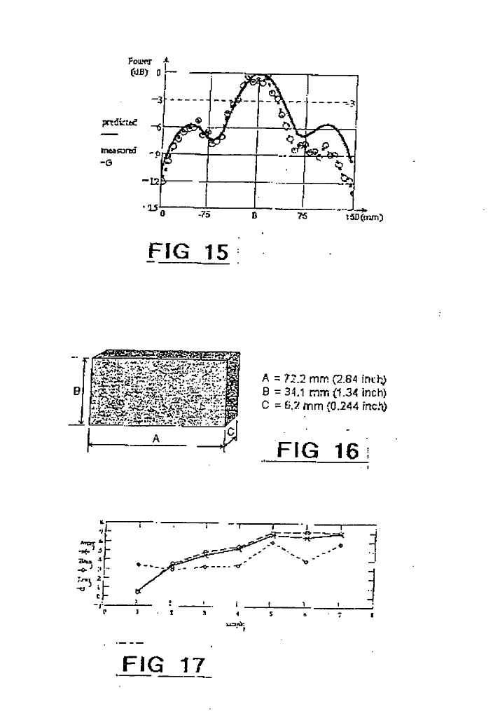

FIGS. 14 and 15 show the predicted and measured normalised power distribution for 4×4 arrays as described in the implementation example above having a 126 mm focal length and a 300 mm focal length respectively, at 10 GHz.

Sensor Application

As mentioned above, the invention has application for sensing solutions. We have found that the antenna has very good sensitivity, enabling it to be used in a sensor system to distinguish between materials (for example natural products such as fruit or wood) with small differences in permittivity values (for example fruit having a rotten core or wood having low density portions or gaps).

Three antenna configurations were compared, namely horn antenna, horn with a dielectric lens and focused beam antenna. Since dielectric lens systems have been used successfully for non-contact sensing, this can be used as a demonstration of the suitability of a focused beam antenna array as a sensor for non-contact and non-destructive permittivity sensing applications.

The transmission measurements were performed using a HP8720C Automatic Network Analyser, after a full two-port calibration at the antenna connectors, followed by a response calibration of the complete measurement system. The samples used in the investigation all had the same dimensions as shown in FIG. 16 where A=72.2 mm, B=34.1 mm, and C=6.2 mm.

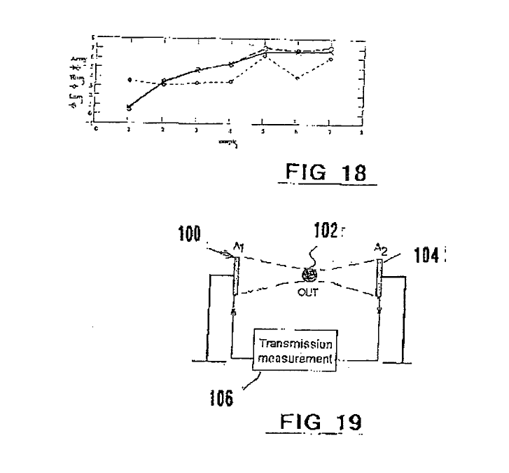

Seven different materials were measured: Foam (UPVC), Teflon (Polytetrafluoroethylene), Acrylic (Polymethyl Metacrylate), Nylon (Hexamethylene Adipamide), Thordon, Carbon induced Teflon and Eccosorb (Silicone Rubber). The permittivity values for these materials are given in Table II. The values for dielectric constant (ε′) and loss tangent (tanδ) were obtained from available literature or measured using a waveguide cell. Complex transmission coefficients (S21) were measured over the frequency range from 10 to 12 GHz. The real and imaginary parts of the transmission coefficient obtained by each of the three sensor systems were averaged over the frequency range and the results are shown in FIGS. 17 and 18, respectively, with the samples ordered along the horizontal axis in order of increasing permittivity. The measured real and imaginary part of transmission coefficient is plotted for the seven dielectric samples (1=Foam, 2=Teflon, 3=Acrylic, 4=Nylon, 5=Thordon, 6=Carbon induced Teflon, 7=Eccosorb).

TABLE II
PERMITTIVITIES OF THE SAMPLES

| | | | | | Thor- | Carbon + | Ecco- |
|---|---|---|---|---|---|---|---|
| | Foam | Teflon | Acrylic | Nylon | don | Teflon | sorb |
| ε′ | 1.04 | 2.08 | 2.59 | 3.02 | 3.7 | 12.7 | 23.6 |
| tan δ | 0.00015 | 0.00037 | 0.0067 | 0.0107 | 0.06 | 0.33 | 0.03 |

The results labeled ‘Array’ were obtained using the exemplary 4×4 implementation of focused beam antenna array (300 mm focal distance) as decribed earlier in this document. From these results it can be concluded that this sensor would be able to distinguish between materials with small differences in permittivity values. Results for the horn antenna with a dielectric lens, are given as ‘Lens’ in FIGS. 17 and 18. Comparing the characteristics for both real and imaginary parts, it is clear that the array antenna and the lens antenna have similar sensitivity. This can be explained by the focusing effect which forces a large proportion of the radiated energy to pass through the object under test therefore maximising the interaction between the passing wave and the material under test. However, this is not so for the horn antenna sensor (‘Horn’ at FIGS. 17 and 18) which does not show the same sensitivity. The sensor is able to distinguish between the low loss and high loss materials, but is not suitable for monitoring small changes in measured permittivity, particularly for the low loss samples.

In FIG. 19, use of the antenna array 100 of the invention is illustrated in a sensor application. The array 100 transmits microwave signals that are focused so that a significant proportion of the energy passes through the object 102 and is received by receiving antenna 104. The receiving antenna can take a variety of forms. By measuring the transmission of the wave, or more specifically the attenuation and a phase shift, information about one or more electrical properties of the material under test. Detection and/or measurement apparatus 106 can provide an indication e.g. a signal that is indicative of (but does not necessarily measure) the permittivity of the object. Apparatus 106 can also compare the indication of the permittivity of the object with a reference indication which may be representative of an acceptable or unacceptable permittivity for the object i.e. to provide a signal as to whether or not the object is acceptable or unacceptable.

Thus the invention has particular application in the accurate measurement of the composition and structure of materials such as fruit, vegetables or wood comprising, moisture content, dry matter content and detection of internal defects typically. The invention allows a measurement process which is non-contact to allow easier measurement and assist in avoiding problems with contamination, cleaning and to allow high speed grading or sorting. One particular application of the present invention is disclosed in our co-pending application PCT/NZ03/00070, the contents of which are incorporated herein by reference in their entirety.

Where in the foregoing description, reference has been made to specific integers or components having known equivalents, then such equivalents are hereby included herein as if individually set forth.

Although the present invention has been discussed in considerable detail with reference to certain preferred embodiments, other embodiments are possible. Therefore, the scope of the appended claims should not be limited to the description of preferred embodiments contained in this disclosure. All references cited herein are incorporated by reference to their entirety.

What is claimed is:

1. A focussed beam antenna array comprising a plurality of element antennas and a feeding network connecting said element antennas and one or more microwave sources and providing a feeding coefficient for each element antenna, wherein either one or both of:
the relative position of the element antennas, and
the feeding coefficient for each element antenna
are selected to cause microwave signals transmitted from the antenna array to focus on a required focal surface.

2. A focussed beam antenna array as claimed in claim 1 wherein the relative position of the element antennas or the feeding coefficient for each element antenna, or the relative position of the element antennas and the feeding coefficient for each element antenna is selected to position the beam waist in a predetermined position in a transversal plane relative to the direction of propagation of said microwave signals.

3. A focussed beam antenna array as claimed in claim 1 wherein the required focal surface is at a predetermined focal distance within the near field zone from the element antennas.

4. A focussed beam antenna array as claimed in claim 1 wherein said feeding network includes a power divider or network of power dividers between said one or more sources and said element antennas, so that each element antenna is fed with microwave signals of substantially equal amplitude.

5. A focussed beam antenna array as claimed in claim 1 wherein the element antennas are located relative to each other in a preselected configuration, the configuration selected to assist the focussing of said electromagnetic signals transmitted from said element antennas.

6. A focussed beam antenna array as claimed in claim 1 wherein the element antennas are located at a separation of approximately one wavelength of the transmitted microwave signals from each other.

7. A focussed beam antenna array as claimed in claim 1 wherein the feeding coefficient for each element antenna is determined to cause a phase variation in signals received by the element antennas that is substantially equivalent to the phase variation that would occur in signals transmitted through a portion of a dielectric thin lens having the same radial distance as the element antenna.

8. A focussed beam antenna array as claimed in claim 1 wherein the feeding network may include contolled electronic phase shifters controlled by control means to allow variation of the location of the focal surface.

9. A focussed beam antenna array as claimed in claim 1 wherein the antenna array includes no refractive elements.

10. A method of producing a focussed beam antenna array, the method comprising providing one or more element antennas for receiving microwave signals from a microwave source and transmitting microwave signals, wherein the method includes one or both of:
locating the element antennas at certain locations relative to each other; and
selecting a certain feeding coefficient for each element antenna
in order to achieve a phase variation in microwave signals across the antenna array that causes the antenna array to have a predetermined focal surface at a required distance from said element antennas.

11. A method as claimed in claim 10 comprising selecting the feeding coeffcients for each element antenna to position the beam waist in a required position in a transversal plane relative to the direction of propagation of said microwave signals.

12. A method as claimed in claim 10 comprising locating the element antennas with varying separation in a plane transverse to a direction of transmission of the antenna array in order to achieve a focussing effect.

13. A method as claimed in claim 10 comprising locating the element antennas at different locations along the axis of transmission of the antenna array in order to achieve a focussing effect.

14. A method as claimed in claim 10 wherein the focal surface is located within the near field zone of said antenna array.

15. A method as claimed in claims 10 comprising selecting the feeding coefficient for each element antenna so that the antenna array simulates a dielectric thin film lens.

16. A method as claimed in claim 10 comprising one or both of:
(i) changing the electrical length of transmission lines to each antenna element; and
(ii) using phase shifters to set the feeding coefficient for each element antenna.

17. A sensor for sensing a property of an object, the sensor comprising:
a) a focussed beam transmitting antenna array comprising a plurality of element antennas and a feeding network connecting said element antennas and one or more microwave sources and providing a feeding coefficient for each element antenna, wherein either one or both of the relative position of the element antennas, and the feeding coefficient for each element antenna are selected to cause microwave signals transmitted from the antenna array to focus on the object;
b) a receiving antenna to receive microwave signals that have passed through the object; and
c) a detection means to determine an indication of the property of the object.

18. A sensor as claimed in claim 17 wherein the detection means determines an indication of an electrical property of the object.

19. A sensor as claimed in claim 18 wherein the electrical property is permitivitty.

20. A sensor as claimed in claim 17 wherein the property includes one or more of permittivity, moisture content, density.

21. A sensor as claimed in claim 17 wherein the detection means includes means to compare the detected indication with a reference indication and provide a signal if the detected indication is greater then or less than the reference indication.

22. A method of sensing a property of an object, the method comprising:
a) providing one or more element antennas for receiving microwave signals from a microwave source; and
b) performing one or both of:
locating the element antennas at selected locations relative to each other, and selecting a certain feeding coefficient for each element antenna,
in order to achieve a phase variation in microwave signals across the antenna array that causes the antenna array to have a predetermined focal surface at a required distance from the element antennas;
c) transmitting microwave signals from the array to the object so that the microwave signals transmitted from the antenna array focus on the object;
d) receiving microwave signals that have passed through the object; and
e) using the received signals to determine an indication of the property of the object.

23. A method as claimed in claim 22 further comprising the steps of comparing the detected indication with a reference indication and providing a signal if the detected indication is greater then or less than the reference indication.
